(19) United States
(12) Patent Application Publication
(10) Pub. No.: US 2006/0172701 A1
(43) Pub. Date: Aug. 3, 2006

(54) Method, device and system for communications with a wireless communications device

(76) Inventor: Juergen Kienhoefer, Santa Cruz, CA (US)

Correspondence Address: PATRICK REILLY, BOX 7218, SANTA CRUZ, CA, 95061-7218, US

(21) Appl. No.: 11/049,794

(22) Filed: Feb. 2, 2005

(51) Int. Cl. H04B 7/00

(52) U.S. Cl. 455/41.2

(57) ABSTRACT

A method, device and system are provided that enable communication of critical information from a wireless communication device, such as a BLUETOOTH slave device. The method allows the wireless communications device to operate in a power conserving mode whereby the critical information is transmitted in a single message that is bundled with identification data of the wireless communications device. The wireless communications device maybe an RFID device.

### BACKGROUND OF THE INVENTION

1. Field of the Invention

The present invention relates to the field of short distance wireless communications. More specifically, the present invention relates to enabling power efficiency in short distance wireless communications between an inquiring electronic device and an information bearing electronic device.

2. Description of the Prior Art

Many communication system standards have been deployed for wireless communication among electronic devices, computational devices and within computer networks. Radio Frequency Identification Device (“RFID”) system standards and the BLUETOOTH are applied to enable communications between and/or among electronic devices. The power requirements of electronic devices that operate on battery power or power received from radio frequency transmission is a key determinant of the lifespan and the general applicability of these devices.

In most RFID and BLUETOOTH systems a plurality of slave devices carry information that may be periodically or occasionally accessed by one or more master devices. The slave device is typically designed to be moved removed from an external power source entirely, or to receive power from radio transmissions. The ability of the slave device to operate at low levels of power consumption over long periods of time is therefore of value in many wireless network applications.

In particular, a BLUETOOTH system functions as a short range radio network that accesses the unlicensed 2.4 GHz Industrial Scientific Medical (ISM) band while employing frequency hopping spread spectrum signals. The BLUETOOTH spread spectrum is typically conformed to the communications regulations of a selected jurisdiction. In the United States, for example, the BLUETOOTH standard may be applied in compliance with parts 15 and 18 of the United States Federal Communications Commission (FCC) regulations. Depending upon the intended jurisdiction of deployment, a BLUETOOTH system may send signals using either seventy-nine or twenty-three frequency hopping channels. The communications signal is being transmitted at any given instant in a single one of the channels. A BLUETOOTH signal channel has a bandwidth of one megahertz bandwidth. The channel frequency selections proceed within a pseudo-random channel hopping sequence selected in accordance with the BLUETOOTH system standard.

In the BLUETOOTH communications concept a master device seeks information from a slave device. The slave device, or slave, is assigned a unique 15 digit identification number and may have a name assigned to it within a particular network.

The BLUETOOTH communications protocols include a service discovery mode, a page scan mode and an inquiry scan mode. The service discovery mode is used by the master device to read the 15 digit unique identification number and the assigned name of a slave device. In typical BLUETOOTH networks, the slave enters into page scan mode for 12 milliseconds every 1.2 seconds, and into inquiry scan mode for 12 milliseconds ever 2.6 seconds. The frequency or length of time that the slave device enters into and maintains either mode significantly effects the power consumption by the slave device.

A more complete description of the BLUETOOTH system is available in the specification volume 1, “Specification of the BLUETOOTH System—Core” v1.0 B published Dec. 1, 1999, and the specification volume 2, “Specification of the BLUETOOTH System—Profiles” v1.0 B published Dec. 1, 1999, both under document no. 1.C.47/1.0 B. The volume 1 core specification specifies the radio, baseband, link manager, service discovery protocol, transport layer, and interoperability with different communications protocols. The volume 2 profiles specification specifies the protocols and procedures required for different types of BLUETOOTH applications. Both volumes are available on-line at www.BLUETOOTH.com or through the offices of Telefonaktiebolaget LM Ericsson of Sweden, International Business Machines Corporation, Intel Corporation of the United States of America, Nokia Corporation of Finland, and Toshiba of Japan.

Therefore, there is a need for a reducing the power requirements of a portable communications device operating within a wireless communications network.

### OBJECTS OF THE INVENTION

It is an object of the invention to provide a method to enable wireless communications between a wireless device and at least a second wireless communications device.

It is an optional object of the present invention to provide a portable wireless communications device that is communicatively coupled via wireless transmissions with at least a second wireless device.

It is another optional object of the present invention to provide a communications system having a portable wireless communications device that is communicatively coupled via wireless transmissions with at least a second wireless device.

### SUMMARY OF THE INVENTION

It is therefore an object of the present invention to provide a method using a wireless communications protocol to enable wireless communications between a wireless device and at least a second wireless communications device. This and other objects of the present invention will no doubt become obvious to those of ordinary skill in the art after having read the following summary and detailed description and viewing the figures illustrating the preferred embodiments.

In a first preferred embodiment of the method of the present invention, a first device is configured to operate as BLUETOOTH slave device and a second device is configured to operate as BLUETOOTH master device. The slave device is additionally configured to computationally generate an information and provide the information in response to in service discovery mode to the master device. The slave device may be a portable device and the master device may be communicatively linked to the Internet or another electronic communications network. The term portable device is defined herein to include devices that may be carried on the person of an adult human being possessing approximately an average capacity to carry physical objects.

In a second preferred embodiment of the method of the present invention, an RFID device is configured to receive electrical power from a radio wave transmission. The RFID device may then store the electrical power and use the stored electrical power to energize elements of the RFID and to transmit the information to a transponder or other communications device configured to receive transmitted communications from the RFID device.

Although the preferred embodiments are described in terms of a BLUETOOTH or an RFID system network, the present invention is applicable to suitable other wireless communication system networks known in the art using wireless identification discovery requests.

### BRIEF DESCRIPTION OF THE DRAWINGS

These, and further features of the invention, may be better understood with reference to the accompanying specification and drawings depicting the preferred embodiment, in which:

FIGS. 1A and 1B present elements of a BLUETOOTH communications protocol and other prior art communications protocols.

FIG. 2 is a partial schematic of a BLUETHOOTH service discovery response message from a slave device and containing a device identification number and a name field, wherein the service discovery message is sent to a master device.

FIG. 3A is a schematic diagram of a BLUETOOTH compliant slave device.

FIG. 3B is a block diagram of an alternate design of the wireless slave device of FIG. 3B.

FIG. 4 is a schematic of a BLUETOOTH compliant master device.

FIG. 5 is a schematic diagram showing the slave device of FIG. 3A and the master device of FIG. 4 communicatively coupled, and wherein the master device is communicatively coupled with an electronic communications system.

FIG. 6 is a process chart of a first preferred embodiment of the present invention that may be practiced by the slave device of FIG. 3A and the master device of FIG. 4 when the slave device and the master device are communicatively coupled.

FIG. 7 is a schematic drawing of an RFID device configured to respond to a device identification request, such as a BLUETOOTH service discovery communication.

### DETAILED DESCRIPTION OF THE PREFERRED EMBODIMENTS

The following description is provided to enable any person skilled in the art to make and use the invention and sets forth the best modes contemplated by the inventor of carrying out his or her invention. Various modifications, however, will remain readily apparent to those skilled in the art, since the generic principles of the present invention have been defined herein.

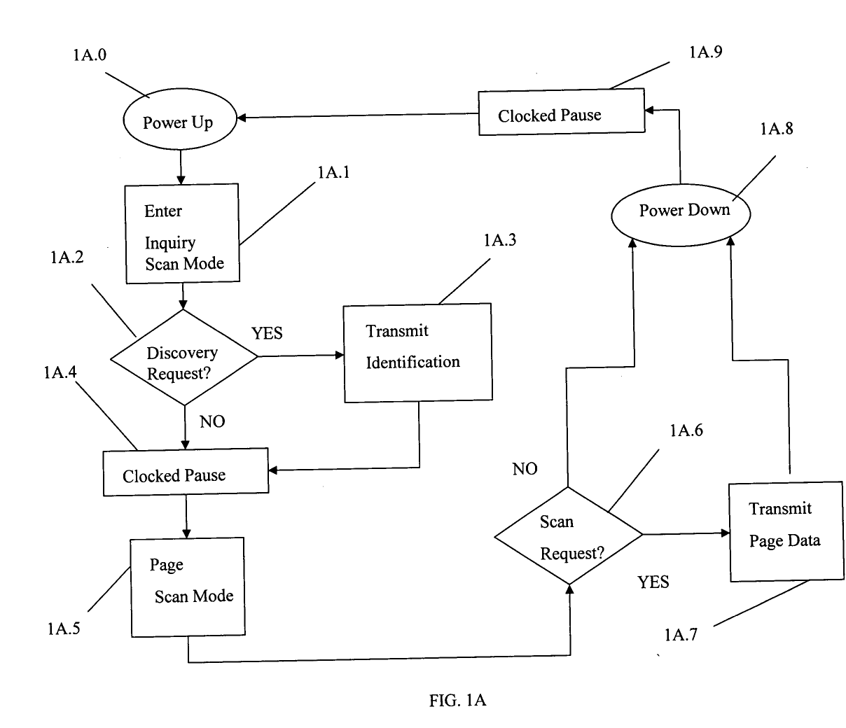

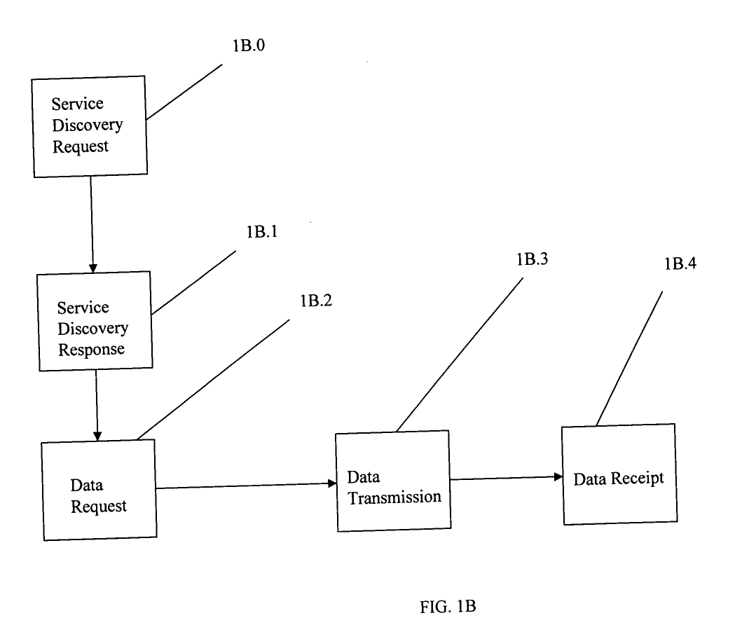

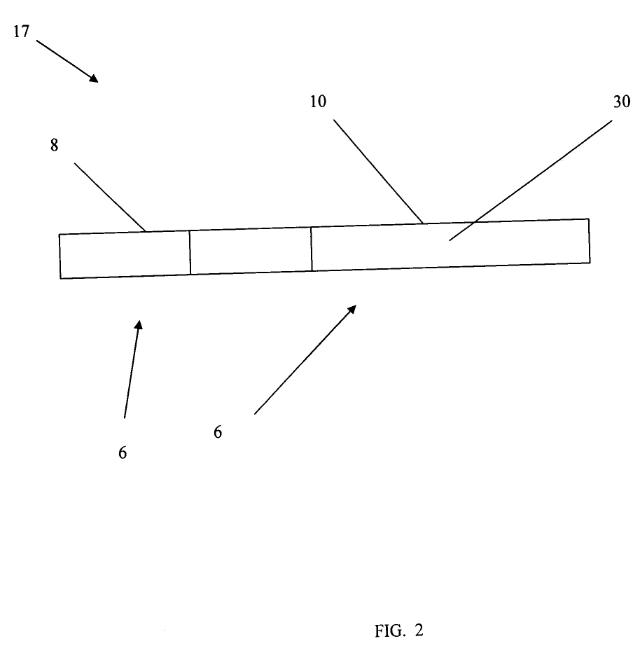

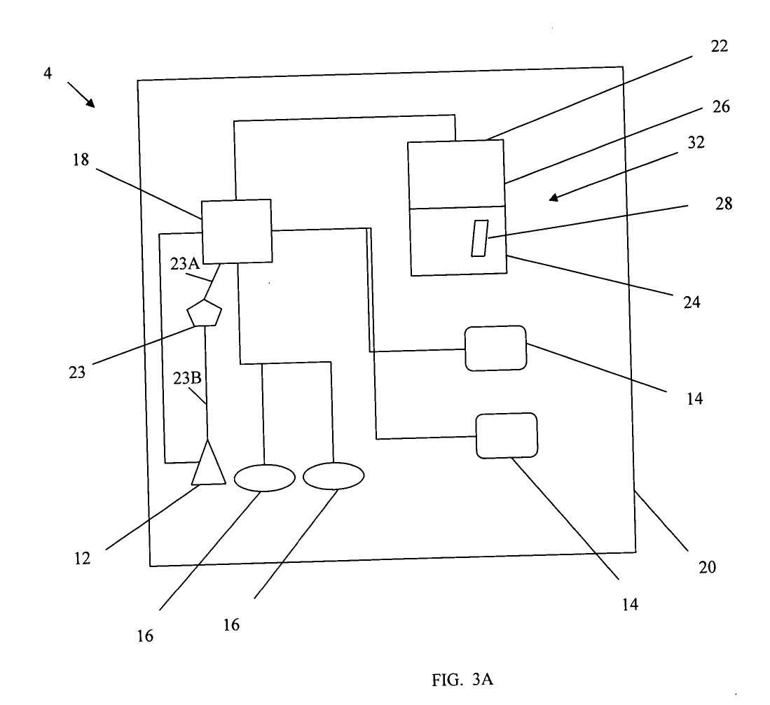

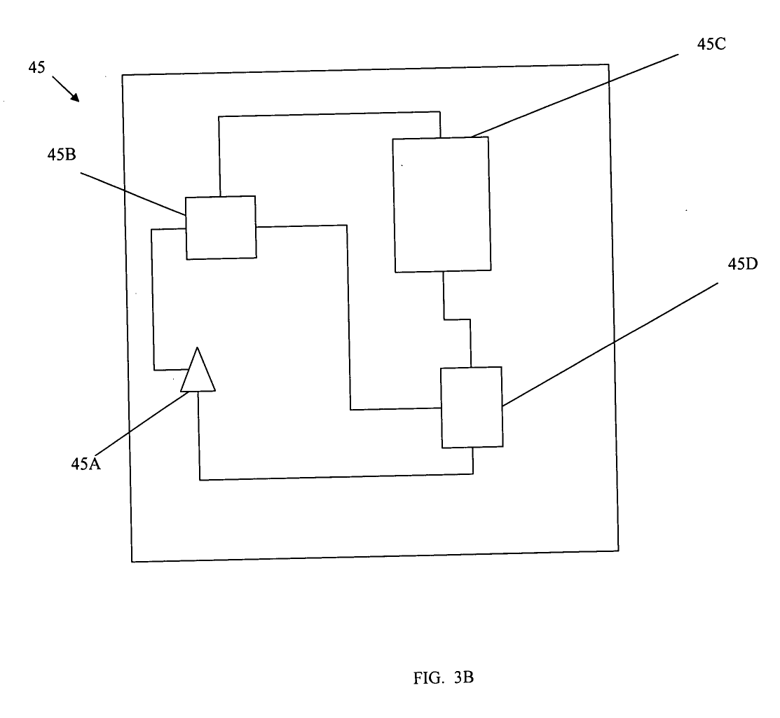

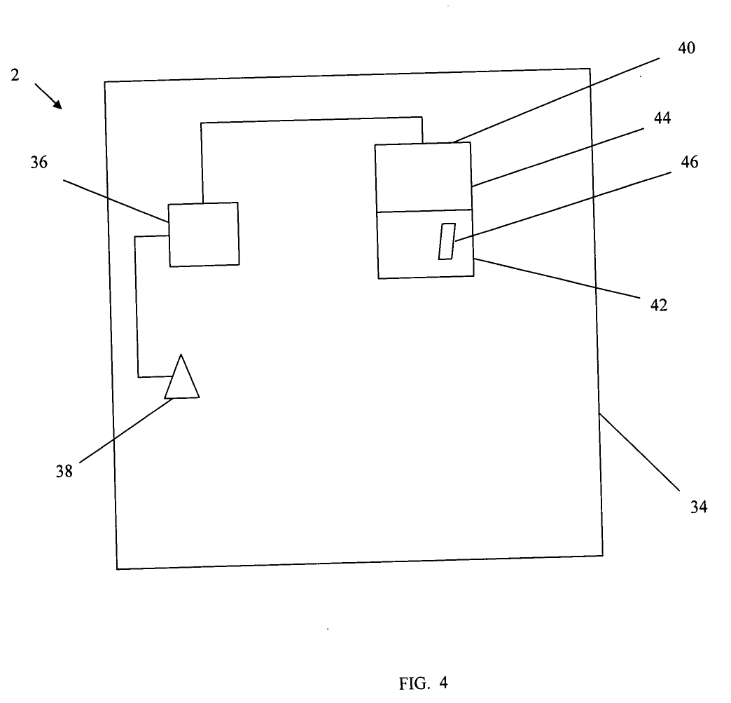

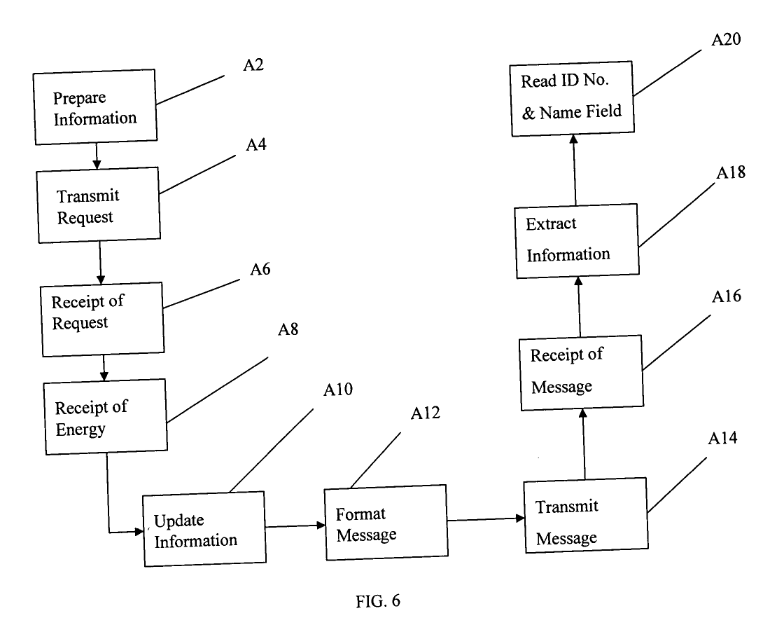

Referring now generally to the Figures and particularly to FIG. 1A, FIG. 1B, FIG. 2 FIG., FIG. 3A, FIG. 3B, FIG. 4 and FIG. 6, FIG. 1A and FIG. 1B present elements of a BLUETOOTH communications protocol. It is understood that one of ordinary skill in the art may select and apply other suitable communications standards, protocols, equipment and systems known in the art to provide information to a master device 2 of FIG. 4 by a slave device 4 of FIG. 3A, and/or the alternate slave device of FIG. 3B.

Referring now generally to the Figures and particularly to FIG. 1A, in the prior art Blue Tooth method of FIG. 1A the slave device may be programmed and enabled to power up periodically to enter into either an inquiry scan mode or a page scan mode. It is understood that there may be additional power down and power up steps within prior art embodiments of the BLUETOOTH standard and other prior art embodiments of the prior art method presented in FIG. 1A or FIG. 1B. As the prior art method of FIG. 1A illustrates, the slave device 4 powers up in step1A.0. In step 1A.1 the slave device 4 enters into an inquiry scan mode for a period of time T1, wherein the slave device 4 is enabled to receive and respond to a service discovery request form the master device 2. As shown in step 1A.2, if the slave device 4 detects a service discovery request from the master device 2 within the duration of T1, (i.e., while the inquiry scan mode is maintained by the slave device 4), and wherein the service discovery request is formatted and transmitted in accordance with the BLUETOOTH standard, then the slave device 4 responds in step A1.3 by transmitting a service discovery response message to the master device 2, wherein the service discovery response message is formatted and transmitted in accordance with the BLUETOOTH standard. If the slave device 4 fails to detect a service discovery request from the master device 2 while the inquiry scan mode is maintained by the slave device 4, then the slave device 4 powers down in a power down step (not shown) and waits for a period of time T2 as per step A1.4, before powering up (in a step not shown), after which the slave device 4 then proceeds onto step A1.5 wherein the slave device 4 enters into a page scan mode for a period of time T3. As shown in step 1A.6, if the slave device 4 detects a page scan request from the master device 2 within the duration of T3, (i.e., while the page scan mode is maintained by the slave device 4), and wherein the page scan request is formatted and transmitted in accordance with the BLUETOOTH standard, then the slave device 4 responds in step A1.7 by transmitting a page scan response message to the master device 2, wherein the page scan response message is formatted and transmitted in accordance with the BLUETOOTH standard. If the slave device 4 fails to detect a page scan request from the master device 2 while the page scan mode is maintained by the slave device 4, or after an executed step A1.7, the slave device 4 powers down in a power down step A1.8 and waits for a period of time T4 as per step A1.9 before returning to step A1.0 and powering up. The time periods T1, T2, T3 and T4 may be calculated and effected by the slave device 4 by accumulating clock pulses from a digital clock signal, or by an other suitable method known in the to determine a passage of time. It is understood that the time T1 may be on the order of 12 milliseconds, and that the time T2 may be on the order of 2.6 seconds. It is further understood that time T4 may be on the order of 1.2 seconds, and that the steps A1.1 and A1.5 may be timed to occur periodically and independently from each other.

Referring now generally to the Figures and particularly to FIG. 1B, an alternate prior art method, that may in certain preferred embodiments of the present invention operate within the requirements of the BLUETOOTH standard, the slave device 4 executes steps 1B.0 through 1B.4, whereby the master device 2 requests and receives data from the slave device 4.

The slave device 4 prepares an information 6 in step A2 of FIG. 6. As illustrated in FIG. 2, the information 6 contains a device identification number 8 and a name field 10. In step A4 of FIG. 6, the master device 2 of FIG. 4 transmits a service discovery request in accordance with the BLUETOOTH standard and within a first radio signal transmission. In step A6 the slave device 4 receives the service discovery request via a wireless transceiver 12. Where the slave device 4 is a radio frequency identification device (“RFID”), the slave device 4 may receive and store energy transmitted from the master device 2 in an optional step A8. In another optional step A10 the slave device 4 updates, generates or creates the information 6 at least partly on the basis of data supplied from or generated by at least one of a plurality of sensors 14 and or elements 16 of the slave device 4, whereby the information 6 of step A2 is newly formed or updated. It is understood that sensors 14 and elements 16 may comprise a wireless device 16 and/or an analog to digital converter 14 and/or a digital to analog converter 14, and that elements 16 and sensor 14 may be or comprise data sources 14, 16 that provide information to the slave device 4. In step A12 the slave device 4 formats a service discovery response message 17 of FIG. 2, the discovery response message 17 comprising the information 6. In step A14 the slave device 4 transmits the information 6 in the discovery response message 17 to the master device 2 via a radio transmission of the transceiver 12. In step A16 the master device 2 receives the radio transmission of the slave device of step A14. In step A18 the master device 2 extracts the information 6 from the discovery response message 17. The master device 2 then reads the device identification number 8 and the name field 10 of the information 6 in step A20.

Referring now generally to the Figures and particularly to FIG. 2 and FIG. 3A, FIG. 3B, FIG. 2 is a representation of a partial schematic of a BLUETHOOTH service discovery response message from the slave device 4 and containing the device identification number 8 and the name field 10, whereby the service discovery response message 17 is sent to the master device 2. The name field 10 is populated with data communicated from and/or generated by a central processor (“CPU”) 18 of the slave device 4.

Referring now generally to the Figures and particularly to FIG. 3A, FIG. 3A is a schematic diagram of the BLUETOOTH compliant slave device 4. The slave device 4 includes a semiconductor module 20 comprising the CPU 18, the transceiver 12, the plurality of sensors 14, the plurality of elements 16, a memory module 22, and a battery 23. The battery 23 is linked with the CPU 18, or computational engine 18, and the transceiver 12, transmission module 12, and the battery 23 provides electrical power to the computational engine 17 (via power line 23A) and to the transmission module 12 (via power line 23B). The memory module 22 includes an operational memory 24 and a refreshable memory 26. The operational memory 24 stores an operating software program 28, the operating software program 28 directing the CPU 18 to (a.) receive data from the transceiver 12, the plurality of sensors 14, the plurality of elements 16, and the memory module 22, (b.) generate message data 30, (c.) populate the name field 10 with the message data 30, (d.) form the message 17 with the name field data 10 and the device identification number 8, and (e.) transmit the message 17 via the transceiver 12 to the master device 2 in response to the receipt of the service discovery request. The refreshable memory 26 is used by the CPU 18 and as directed by the software program 28 to generate the message 17. The refreshable memory 26 and operational memory 24 the may be or comprise a random access memory 32 or other suitable refreshable memory device known in the art.

Referring now generally to the Figures and particularly to FIG. 4, FIG. 4 is a schematic of a BLUETOOTH compliant master device. The master device 2 includes a semiconductor module 34 comprising a master central processing unit (“master CPU”) 36, a master transceiver 38, and a memory module 40. The memory module 40 includes an operational memory 42 and a refreshable memory 44. The operational memory 42 stores a master operating software program (“master software”) 46, the master software 46 directing the master CPU 36 to (a.) generate the service discovery request 12, (b.) transmit the service discovery request 12 via receive data from the master transceiver 38, (c.) receive the message 22 via the master transceiver 38, (d.) extract the device identification number 8 and the message data 32 from the name field 10 and (e.) store the device identification number 8 and the message data 30 in the refreshable memory 44. The refreshable memory 44 and the may be or comprise a random access memory or other suitable refreshable memory device known in the art. Referring now generally to the Figures and particularly to FIG. 3B, FIG. 3B is a schematic diagram of an alternate slave device 45, or alternate device 45. The alternate device 45 includes an antenna 45A, a controller 45B, a sensor 45C, and a battery 45D. The antenna 45A provides a bi-directional radio frequency signal pathway between the controller 45B and the master device 2. The sensor 45C monitors a parameter, such as a temperature or an intensity of light, and reports an observed parameter value to the controller 45B. The controller 45B records the observed parameter value and transmits the observed parameter value to master device 2 in a response to a discovery request transmission from the master device 2. The battery 45D provides electrical power to the controller 45B and optionally sensor 4B and sensor 45C as required. The controller 45B may optionally include (1) a Bluetooth device containing base band processor and radio circuit, as well as the application software code, or other suitable communications and computing device known in the art; (2) memory for storing data and scripts how to operate sensors, and power switches to enable external sensors, e.g. 45C. The sensor 45C may optionally include (1.) sensor interface, e.g. a 1-wire sensor interface; (2) an external sensor interface; (3) parameter sensors, e.g., an iButton, a current and/or a voltage sensors for the batteries; (4) power supplies, e.g., a primary battery, a rechargeable battery with recharger, solar; and/or (5) power switches to switch between various sources.

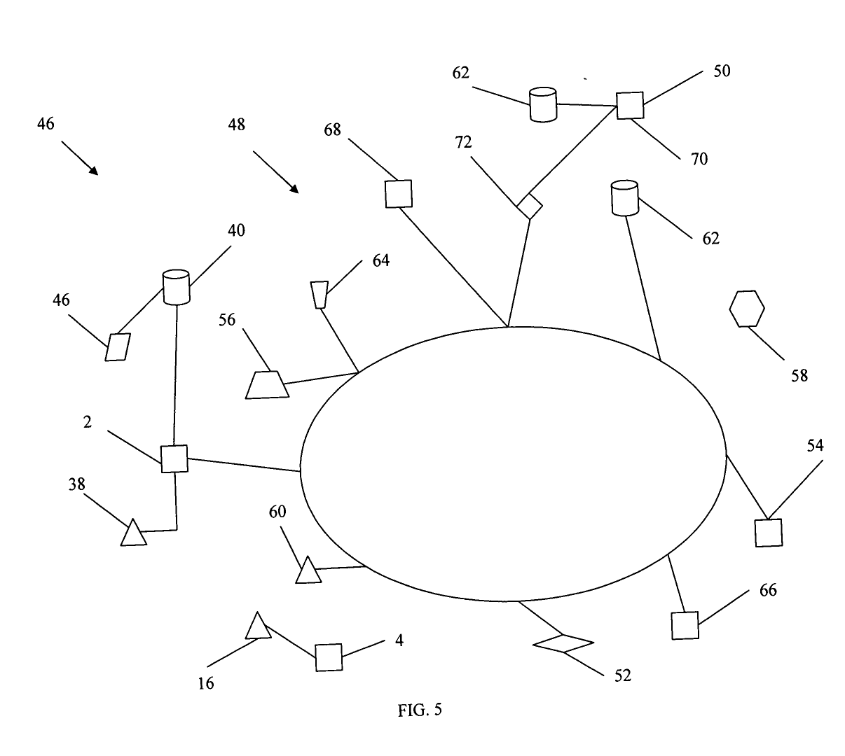

Referring now generally to the Figures and particularly to FIGS. 3A, 3B, 4 and 5, FIG. 5 is a schematic diagram showing the slave device 4 of FIG. 3A, or the alternate slave device .X of FIG. 3B, and the master device 2 of FIG. 4 communicatively coupled, and wherein the master device 2 is communicatively coupled with an electronic communications system 46. The communications system 46 includes a communications network 48, and a variety of elements 50, to include computational systems 52, personal computers 54, sensing devices 56, wireless communications devices 58, wireless communications transponders 60, memory modules 62, telephones 64, electronic communications instruments 66, and electronic devices 68. The wireless communications transponders 60 are configured to provide unidirectional or bidirectional communications between the wireless communications devices 58 and the communications network 48. The wireless communications devices 58 may be or comprise computational devices such as personal digital assistants, or telephony systems, such as cellular telephones. An admin workstation 70, and the elements 50, to include the computational systems 52, the personal computers 54, the sensing devices 56, the wireless communications devices 58, the wireless communications transponders 60, the memory modules 62, the telephones 64, the electronic communications instruments 66, and the electronic devices 68 communicate either directly or via an intermediate electronic communications device 72. The communications network 48 may be or comprise the Internet, an intranet, an extranet, a computer network, a telephony network, a wireless telephony network, and/or a wireless communications network.

Referring now generally to the Figures and particularly to FIG. 6, FIG. 6 is a process chart of a first preferred embodiment of the present invention that may be practiced by the slave device of FIG. 3A and the master device of FIG. 4 when the slave device and the master device communicatively coupled.

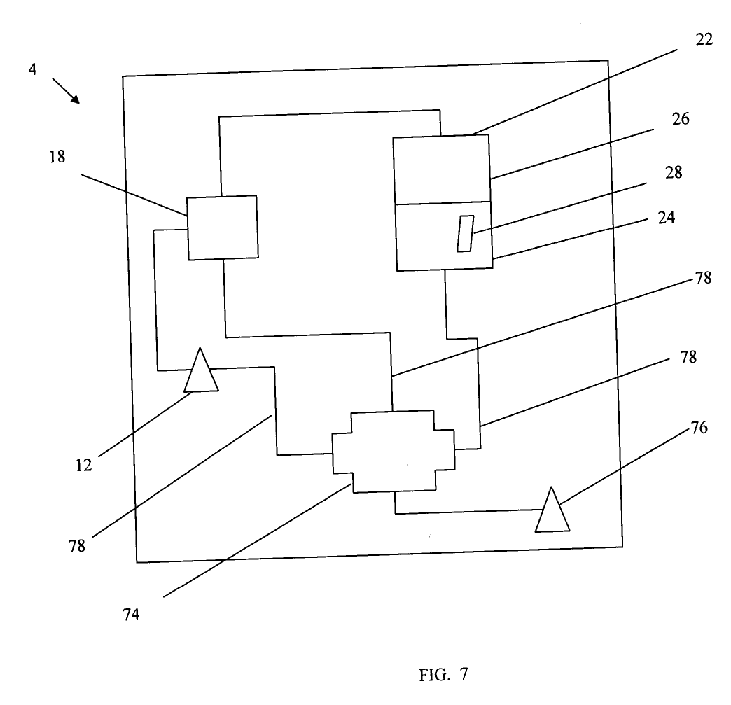

Referring now generally to the Figures and particularly to FIG. 7, FIG. 7 is a schematic drawing of an RFID device configured to respond to a device identification request, such as a BLUETOOTH service discovery communication. An RFID radio energy storage 72 receives and stores radio energy transmitted from the master device 2 and to the energy transceiver 74. The energy storage 72 then provides electrical power to the elements of the slave device 4, to include the CPU 18, the transceiver 12 and the memory module 25 via a plurality of power transmission traces 76.

Although the examples given include many specificities, they are intended as illustrative of only one possible embodiment of the invention. Other embodiments and modifications will, no doubt, occur to those skilled in the art. Thus, the examples given should only be interpreted as illustrations of some of the preferred embodiments of the invention, and the full scope of the invention should be determined by the appended claims and their legal equivalents.

I claim:

1. A method used within a BLUETOOTH wireless communications network, the network having a BLUETOOTH slave device and a BLUETOOTH master device, the BLUETOOTH slave device having a computational module capable or formatting an information within the device name BLUETOOTH standard, the method comprising:
providing the computational module of the slave device with a first data;
directing the computational module to generate an information, the information containing at least some of an informational content of the first data, and the information formatting in compliance with the BLUETOOTH device name standard;
placing the master device and the slave device into a BLUETOOTH service discovery mode; and
transmitting an identification of the slave and the information from the slave device and to the master device in compliance with the service discovery protocol.

2. The method of claim 1, wherein the slave device is a portable device.

3. The method of claim 1, wherein the slave device is coupled with an equipment.

4. The method of claim 1, wherein the master device is communicatively coupled to an electronic communications network, the electronic communications network selected from the group consisting of the Internet, an intranet, an extranet, a computer network, a telephony network, and a wireless communications network.

5. The method of claim 1, wherein the slave device is an RFID device.

6. The method of claim 5, wherein the master device further comprises an RFID energy transmitter, whereby the master device provides electrical power to the slave device by means of radio wave transmission.

7. A wireless communications system, the system comprising:
a first device, the first device configured as a BLUETOOTH slave device, and comprising a computational engine and a data source;
the computational engine communicatively coupled with the data source, and the first device configured to receive a first data from the data source, direct the computational engine to generate an information formatting in compliance with the BLUETOOTH device name standard, and the information containing at some of an informational content of the first data; and
a second device, the second device configured as a BLUETOOTH master device, whereby the second device receives the information from the first device in a device name field of a service discovery communication.

8. The system of claim 1, wherein the slave device is a portable device.

9. The system of claim 1, wherein the slave device is coupled with an equipment.

10. The system of claim 1, wherein the master device is communicatively coupled to an electronic communications network, the electronic communications network selected from the group consisting of the Internet, an intranet, an extranet, a computer network, a telephony network, and a wireless communications network

11. The system of claim 1, wherein the slave device is an RFID device

12. The system of claim 10, wherein the master device further comprises an RFID energy transmitter, whereby the master device provides electrical power to the slave device by means of radio wave transmission.

13. An electronics communications device comprised within a wireless communications network, the device comprising;
a data source, the data source providing data for transmission to the wireless communications network;
a computational engine, the computational engine communicatively linked to the data source, and the computational engine for recording at least some of the data into a device name format;
a wireless transmission module, the wireless transmission module communicatively linked with the computational engine, whereby the at least some of the data is provided to the network in the device name format.

14. The device of claim 13, wherein the device further comprises an electrical power battery, the battery linked with the computational engine and the transmission module and the battery providing electrical power to the computational engine and to the transmission module.

15. The device of claim 13, wherein the device is an RFID device.

16. The device of claim 13, wherein the device further comprises a radio frequency energy model, the radio frequency radio receiver linked to the computational engine, and the radio frequency energy module for accepting electrical power from a radio signal and providing electrical power to the computational engine and to the transmission module.

17. The device of claim 13, wherein the device is a portable device.

18. The device of claim 13, wherein the data source is an analog to digital converter.

19. The device of claim 13, wherein the data source is an electronic sensor.

20. The device of claim 13, wherein the data source is a wireless communications device.
